(19) United States
(12) Patent Application Publication
(10) Pub. No.: US 2023/0064940 A1
(43) Pub. Date: Mar. 2, 2023

(54) METHOD FOR OPTIMIZING DISPATCHING OF CHARGING LOADS OF ELECTRIC VEHICLES TO PROMOTE WIND POWER CONSUMPTION

(71) Applicants: State Grid Shanghai Electric Power Company, Shanghai (CN); Shanghai Electric Power Trading Center Co.,Ltd., Shanghai (CN); North China Electric Power University, Beijing (CN); State Grid Electric Power Research Institute Co., Ltd., Nanjing (CN); Beijing KeDong Electric Power Control System Co., Ltd., Beijing (CN); State Grid Electric Vehicle Service Company, Beijing (CN)

(72) Inventors: Dunnan LIU, Beijing (CN); Mingguang LIU, Beijing (CN); Ping SONG, Shanghai (CN); Yue SHEN, Shanghai (CN); Li TAO, Nanjing (CN); Hua ZHONG, Shanghai (CN); Tao YU, Shanghai (CN); Wen WANG, Beijing (CN); Chunyi CHEN, Shanghai (CN); Jian LIU, Nanjing (CN); Tingting ZHANG, Beijing (CN); Yue XI, Beijing (CN); Jianye ZOU, Beijing (CN); Xin DU, Beijing (CN); Lin ZHANG, Beijing (CN); Ye YANG, Beijing (CN); Shu SU, Beijing (CN)

(21) Appl. No.: 17/862,032

(22) Filed: Jul. 11, 2022

(30) Foreign Application Priority Data
Sep. 1, 2021 (CN) 202111021241.0

(51) Int. Cl. B60L 53/64; B60L 53/63; B60L 53/52; H02J 3/14; G06Q 50/06

(52) U.S. Cl. CPC B60L 53/64; B60L 53/63; B60L 53/52; H02J 3/144; G06Q 50/06; H02J 2300/28

(57) ABSTRACT

A method for optimizing dispatching of charging loads of electric vehicles to promote wind power consumption includes: acquiring blocked electric quantity of wind power at a peak down-regulation period; acquiring a curve of disorderly charging loads of the electric vehicles; establishing a model for optimizing the charging loads of the electric vehicles to promote wind power consumption, wherein an objective function of the model refers to that the electric vehicles participate in wind power consumption to minimize the remaining blocked quantity of the wind power, and the total charging cost of the electric vehicles is lowest, and acquiring constraint conditions of the model; and solving the optimization model by adopting an adaptive mutation particle swarm optimization algorithm, to obtain the target charging/discharging electric quantity and the target charging/discharging power of the electric vehicles.

### CROSS REFERENCE TO RELATED APPLICATIONS

This application claims foreign priority of Chinese Patent Application No. 202111021241.0, filed on Sep. 1, 2021 in the China National Intellectual Property Administration, the disclosures of all of which are hereby incorporated by reference.

### TECHNICAL FIELD

The present invention belongs to the technical field of application of regulation & control and wind power consumption of electric vehicles, and particularly relates to a method for optimizing dispatching of charging loads of electric vehicles to promote wind power consumption.

### BACKGROUND OF THE PRESENT INVENTION

With continuous expansion of the scale of construction and access of wind power plants, the security and stability of a power grid is affected by the uncertainty and randomness of wind power generation. In a case of large-scale wind power integration, the output adjustment speed of a conventional power supply, such as a thermal power generating unit and the like, is lower; and the unit is constrained by minimum technical output and the like, leading to that the down-regulation space at the power supply side of the power grid is limited, and meanwhile, the feature of reverse peak regulation of wind power leads to that the power of source loads is unbalanced at night. Due to the nature climate that wind is strong at night generally and the power utilization habit of people that the power utilization of people is less at night generally, superposed loads are lower than the lower limit of peak regulation of the conventional power supply at night, however, the inadequate capacity of peak down-regulation of the conventional power supply leads to that a system cannot consume remaining wind power, so that a lot of wind abandonment phenomena occur.

An electric vehicle serving as a transportation means capable of consuming clean energy attracts much attention. A lot of electric vehicles are charged disorderly, possibly leading to the problem of ‘peak on peak’ of the power grid, the problem of intensified traffic jam and the like. In order to positively consume renewable energy sources and improve the utilization rate of wind power, the electric vehicles can be guided to be charged/discharged at the load side to participate in wind power consumption. Therefore, how to improve the positivity that users of the electric vehicles participate in dispatching of power grids and promote wind power consumption to be maximized is an important problem; and in view of the above problems, it is necessary to research a method for optimizing dispatching of charging loads of the electric vehicles to promote wind power consumption to be maximized, which can be used for solving the problems of a lot of wind abandonment phenomena and disorderly charging of the electric vehicles.

### SUMMARY OF PRESENT INVENTION

In order to overcome the defects in the prior art, the present invention provides a method for optimizing dispatching of charging loads of electric vehicles to promote wind power consumption to be maximized, which can be used for solving the problems of a lot of wind abandonment phenomena and disorderly charging of the electric vehicles.

The present invention adopts the following technical solution to solve the technical problems:

The method for optimizing dispatching of the charging loads of the electric vehicles to promote wind power consumption comprises the following steps:

acquiring the blocked electric quantity of wind power at a peak down-regulation period;

acquiring a curve of disorderly charging loads of the electric vehicles;

establishing a model for optimizing the charging loads of the electric vehicles to promote wind power consumption, wherein an objective function of the model refers to that the electric vehicles participate in wind power consumption to minimize the remaining blocked quantity of the wind power, and the total charging cost of the electric vehicles is lowest; and acquiring constraint conditions of the model;

solving the optimization model by adopting an adaptive mutation particle swarm optimization algorithm, to obtain the target charging/discharging electric quantity and the target charging/discharging power of the electric vehicles.

Further, a method of establishing the model for optimizing the charging loads of the electric vehicles to promote wind power consumption comprises:

establishing a model that the electric vehicles participate in wind power consumption to minimize the remaining blocked quantity of the wind power:

f₁=min(E_{B,t}−E_{EV,t}),t∈T

$${E}_{EV , t} = {\sum }_{i = 1}^{{N}_{EV}} {P}_{c , i}^{t} Δ t$$

wherein in the formulas, f₁ represents the remaining blocked quantity of the wind power; E_{B,t} represents the blocked electric quantity at the peak down-regulation period; E_{EV,t} represents the charging electric quantity of the electric vehicles; T represents the peak down-regulation period; P_{C,i}^{t} represents the charging power of an i^{th} electric vehicle at a period t; N_{EV} represents the number of the electric vehicles; and Δt represents the time scale;

establishing the objective function that the total charging cost of the electric vehicles is lowest:

$${f}_{2} = min ( {\sum }_{t = 1}^{n} {\sum }_{i = 1}^{{N}_{EV}} {P}_{c , i}^{t} * {F}_{c , t} - {\sum }_{t = 1}^{n} {\sum }_{i = 1}^{{N}_{EV}} {P}_{f , i}^{t} * {F}_{f , t} )$$

wherein in the formula, f₂ represents the total charging cost of the electric vehicles; P_{c,i}^{t} and P_{f,i}^{t} respectively represent the charging power and the discharging power of the i^{th} electric vehicle at the period t; and F_{c,t} and F_{f,t} respectively represent charging fees and discharging fees of the electric vehicles at the period t.

Further, the constraint conditions of the model comprise a power balance constraint of a system, an output constraint of a wind power plant and relevant constraints of the electric vehicles.

Further, the relevant constraints of the electric vehicles comprise an electric quantity constraint of the electric vehicles, a charging/discharging constraint of the electric vehicles, an SOC (State Of Charge) constraint and an online time constraint of the electric vehicles.

Further, the power balance constraint of the system is:

$${P}_{F , t} + {\sum }_{j = 1}^{{n}_{G}} {u}_{j} * {P}_{G , j}^{t} = {P}_{L , t} + {\sum }_{i = 1}^{{N}_{EV}} ( {P}_{c , i}^{t} * {V}_{i , t} + {P}_{f , i}^{t} * {V}_{i , t} )$$

wherein in the formula, P_{F,t} represents the discharging power of the electric vehicles at the period t; P_{G,j}^{t} represents the active power output of a conventional power supply j at the period t; P_{L,t} represents the value of a system load at the period t; P_{c,i}^{t} and P_{f,i}^{t} respectively represent the charging power and the discharging power of the i^{th} electric vehicle at the period t; uⱼ=1 represents that units operate normally, and uⱼ=0 represents that the units stop operating; V_{i,t} represents a charging state and a discharging state of the i^{th} electric vehicle at the period t, V_{i,t}=1 represents that the vehicle is in the charging state, and V_{i,t}=−1 represents that the vehicle is in the discharging state; and n_{G} represents the number of units, and N_{EV} represents the number of the electric vehicles;

the output constraint of the wind power plant is:

min P_{F,t}≤P_{F,t}≤max P_{F,t}

wherein in the formula, min P_{F,t} and max P_{F,t} respectively represent the upper limit and the lower limit of power of wind power output at t^{th} period;

the electric quantity constraint of the electric vehicles is:

Qᵢ≥Q_{i,t}_{ₙ₁}−P_{f,i}^{t}*Δt_{f}+P_{c,i}^{t}*Δt_{c}

wherein in the formula, Qᵢ represents the electric quantity after the electric vehicles are charged/discharged; Q_{i,t}_{ₙ₁} represents the electric quantity before the electric vehicles are charged/discharged; Δt_{c} and Δt_{f} respectively represent the charging duration and the discharging duration;

the charging/discharging constraint of the electric vehicles is:

0≤P_{c,i}^{t}≤P_{c,max}

0≤P_{f,i}^{t}≤P_{f,max}

P_{c,i}^{t}*P_{f,i}^{t}=0

wherein in the formulas, P_{c,max} represents the upper limit of the charging power of the electric vehicles, and P_{f,max} represents the upper limit of the discharging power of the electric vehicles;

the SOC constraint is:

SOC_{d,i}≤SOC_{e,i}≤SOCₘₐₓ

wherein in the formula, SOC_{e,i} represents an SOC of the i^{th} electric vehicle when the charging is ended; SOC_{d,i} represents an expected SOC of the i^{th} electric vehicle; and SOCₘₐₓ represents the upper limit of charging, which is set by a power battery;

the online time constraint of the electric vehicles is:

Tᵢₙ≤T_{c}≤Tₒᵤₜ

Tᵢₙ≤T_{f}≤Tₒᵤₜ

wherein in the formulas, Tᵢₙ represents the network access time of the electric vehicles; T_{c} represents the charging time of the electric vehicles; Tₒᵤₜ represents the off-network time of the electric vehicles; and T_{f} represents the discharging time of the electric vehicles.

Further, a method of acquiring the blocked electric quantity of the wind power at the peak down-regulation period comprises:

solving the predicted electric quantity E_{F,wind}^{t} of wind power at each period Δt according to a prediction curve of wind power output on a next day:

E_{F,wind}^{t}=P_{F,wind}^{t}*Δt

wherein in the formula, Δt represents the time scale, and P_{F,wind}^{t} represents the power of the wind power output;

setting a peak down-regulation period and a peak non-down-regulation period of the system and acquiring the blocked electric quantity of the wind power:

T={T|E_{F,wind}^{t}≥E_{p,wind}^{t},t∈T}

wherein in the formula, E_{p,wind}^{t} represents planned wind power quantity, and T represents the peak down-regulation period;

acquiring the blocked electric quantity E_{B,t} of the wind power at the peak down-regulation period:

E_{B,t}=E_{F,wind}^{t}−E_{p,wind}^{t},t∈T

The present invention has the advantages and beneficial effects that:

In the method for optimizing dispatching of the charging loads of the electric vehicles, provided by the present invention, the power balance of the system, the output of the wind power plant, the relevant constraints of the electric vehicles and the like are considered; from the aspect that the electric vehicles participate in dispatching of power grids to realize minimization of the charging cost, the electric vehicles participate in wind power consumption to obtain certain benefit, and the positivity of participation of users of the electric vehicles is enhanced; the electric vehicles participate in wind power consumption on a large scale, so that the peak regulation capacity of a power grid system can be enhanced, and the consumption of blocked wind power can be increased; the method provided by the present invention can be applied to guiding a charging/discharging behavior of the electric vehicles, realizes cooperative dispatching with new energy to optimize energy utilization and provides support for reducing impact to the power grids, promoting wind power consumption and improving the charging/discharging economy of the users.

### DESCRIPTION OF THE DRAWINGS

The technical solution of the present invention is further described in detail below through combination with the drawings and embodiments, but it should be known that the drawings are only designed for explanation, and therefore, the drawings are not the limit to the scope of the present invention. Additionally, unless mentioned otherwise, the drawings are only intended to conceptually describe the structure described here, and are not necessarily drawn according to the proportion.

FIG. 1 is a flow hart of a method for optimizing dispatching of charging loads of electric vehicles to promote wind power consumption, provided by an embodiment of the present invention.

### DETAILED DESCRIPTION OF PREFERRED EMBODIMENTS

Firstly, it should be noted that the concrete structure, characteristics and advantages of the present invention are specifically described below in a manner of examples, however, all the descriptions are only used for explanation and should not be understood as any limit to the present invention. Additionally, any single technical feature is described or hidden in all embodiments mentioned herein, and the technical features (or equivalents thereof) can still continue to be combined or deleted randomly, to obtain other more embodiments of the present invention, which are possibly not mentioned directly herein.

It should be noted that under the condition of no conflict, the embodiments in the present application and the features in the embodiments can be combined with one another.

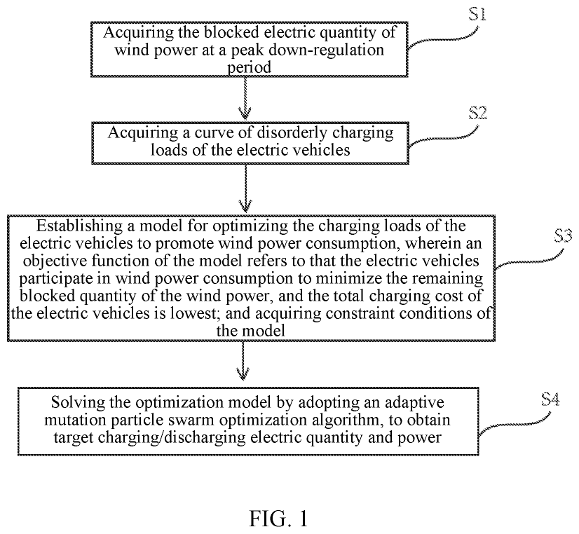

As shown in FIG. 1, the present invention provides a method for optimizing dispatching of charging loads of electric vehicles to promote wind power consumption, which comprises the following steps:

S1, acquiring the blocked electric quantity of wind power at a peak down-regulation period;

S2, acquiring a curve of disorderly charging loads of the electric vehicles;

S3, establishing a model for optimizing the charging loads of the electric vehicles to promote wind power consumption, wherein an objective function of the model refers to that the electric vehicles participate in wind power consumption to minimize the remaining blocked quantity of the wind power, and the total charging cost of the electric vehicles is lowest; and acquiring constraint conditions of the model;

S4, solving the optimization model by adopting an adaptive mutation particle swarm optimization algorithm, to obtain the target charging/discharging electric quantity and the target charging/discharging power.

Specifically, a method of establishing the model for optimizing the charging loads of the electric vehicles to promote wind power consumption comprises:

establishing a model that the electric vehicles participate in wind power consumption to minimize the remaining blocked quantity of the wind power:

$${f}_{1} = min ( {E}_{B , t} - {E}_{EV , t} ) , t ∈ T \\ {E}_{EV , t} = {\sum }_{i = 1}^{{N}_{EV}} {P}_{c , i}^{t} Δ t$$

wherein in the formulas, f₁ represents the remaining blocked quantity of the wind power; E_{B,t} represents the blocked electric quantity at the peak down-regulation period; E_{EV,t} represents the charging electric quantity of the electric vehicles; T represents the peak down-regulation period; P_{c,i}^{t} represents the charging power of an i^{th} electric vehicle at a period t; N_{EV} represents the number of the electric vehicles; Δt represents the time scale; and in specific application, the numerical value of the time scale can be set according to an actual situation, and for example, the time scale can be set as 15 min;

establishing the objective function that the total charging cost of the electric vehicles is lowest:

$${f}_{2} = min ( {\sum }_{t = 1}^{n} {\sum }_{i = 1}^{{N}_{EV}} {P}_{c , i}^{t} * {F}_{c , t} - {\sum }_{t = 1}^{n} {\sum }_{i = 1}^{{N}_{EV}} {P}_{f , i}^{t} * {F}_{f , t} )$$

wherein in the formula, f₂ represents the total charging cost of the electric vehicles; P_{c,i}^{t} and P_{f,i}^{t} respectively represent the charging power and the discharging power of the i^{th} electric vehicle at the period t; and F_{c,t} and F_{f,t} respectively represent charging fees and discharging fees of the electric vehicles at the period t.

Additionally, the constraint conditions comprise a power balance constraint of a system, an output constraint of a wind power plant and relevant constraints of the electric vehicles; and the relevant constraints of the electric vehicles comprise an electric quantity constraint of the electric vehicles, a charging/discharging constraint of the electric vehicles, an SOC constraint and an online time constraint of the electric vehicles.

Specifically, the power balance constraint of the system is:

$${P}_{F , t} + {\sum }_{j = 1}^{{n}_{G}} {u}_{j} * {P}_{G , j}^{t} = {P}_{L , t} + {\sum }_{i = 1}^{{N}_{EV}} ( {P}_{c , i}^{t} * {V}_{i , t} + {P}_{f , i}^{t} * {V}_{i , t} )$$

wherein in the formula, P_{F,t} represents the discharging power of the electric vehicles at the period t; P_{G,j}^{t} represents the active power output of a conventional power supply j at the period t; P_{L,t} represents the value of a system load at the period t; P_{c,i}^{t} and P_{f,i}^{t} respectively represent the charging power and the discharging power of the i^{th} electric vehicle at the period t; uⱼ=1 represents that units operate normally, and uⱼ=0 represents that the units stop operating; V_{i,t} represents a charging state and a discharging state of the i^{th} electric vehicle at the period t, V_{i,t}=1 represents that the vehicle is in the charging state, and V_{i,t}=−1 represents that the vehicle is in the discharging state; and n_{G} represents the number of units, and N_{EV} represents the number of the electric vehicles;

the output constraint of the wind power plant is:

min P_{F,t}≤P_{F,t}≤max P_{F,t}

wherein in the formula, min P_{F,t} and max P_{F,t} respectively represent the upper limit and the lower limit of power of wind power output at t^{th} period;

the electric quantity constraint of the electric vehicles is:

Qᵢ≥Q_{i,t}_{ₙ₁}−P_{f,i}^{t}*Δt_{f}+P_{c,i}^{t}*Δt_{c}

wherein in the formula, Q₁ represents the electric quantity after the electric vehicles are charged/discharged; Q_{i,t}_{ₙ₁} represents the electric quantity before the electric vehicles are charged/discharged; Δt_{c} and Δt_{f} respectively represent the charging duration and the discharging duration;

the charging/discharging constraint of the electric vehicles is:

0≤P_{c,i}^{t}≤P_{c,max}

0≤P_{f,i}^{t}≤P_{f,max}

P_{c,i}^{t}*P_{f,i}^{t}=0

wherein in the formulas, P_{c,max} represents the upper limit of the charging power of the electric vehicles, and P_{f,max} represents the upper limit of the discharging power of the electric vehicles;

the SOC constraint is:

SOC_{d,i}≤SOC_{e,i}≤SOCₘₐₓ

wherein in the formula, SOC_{e,i} represents an SOC of the i^{th} electric vehicle when the charging is ended; SOC_{d,i} represents an expected SOC of the i^{th} electric vehicle; and SOCₘₐₓ represents the upper limit of charging, which is set by a power battery;

the online time constraint of the electric vehicles is: the charging time and the discharging time of the electric vehicles is between the network access time and an off-network time of the electric vehicles;

Tᵢₙ≤T_{c}≤Tₒᵤₜ

Tᵢₙ≤T_{f}≤Tₒᵤₜ

wherein in the formulas, Tᵢₙ represents the network access time of the electric vehicles; T_{c} represents the charging time of the electric vehicles; Tₒᵤₜ represents the off-network time of the electric vehicles; and T_{f} represents the discharging time of the electric vehicles.

Further, a method of acquiring the blocked electric quantity of the wind power at the peak down-regulation period comprises:

solving the predicted electric quantity E_{F,wind}^{t} of wind power at each period Δt according to a prediction curve of wind power output on a next day:

E_{F,wind}^{t}=P_{F,wind}^{t}*Δt

wherein in the formula, Δt represents the time scale, and P_{F,wind}^{t} represents the power of the wind power output;

setting a peak down-regulation period and a peak non-down-regulation period of the system and acquiring the blocked electric quantity of the wind power:

T={T|E_{F,wind}^{t}≥E_{p,wind}^{t},t∈T}

wherein in the formula, E_{p,wind}^{t} represents planned wind power quantity (the wind power quantity consumed by the system load), and T represents the peak down-regulation period;

acquiring the blocked electric quantity E_{B,t} of the wind power at the peak down-regulation period:

E_{B,t}=E_{F,wind}^{t}−E_{p,wind}^{t},t∈T

Additionally, a method of acquiring the curve of the disorderly charging loads of the electric vehicles comprises: acquiring information, such as the quantity, the charging/discharging power, the charging/discharging electric quantity, the travel time proportion and the like of various types of electric vehicles in an area, to obtain a curve of independent charging/discharging loads of the electric vehicles.

It should be noted that the embodiment adopts the adaptive mutation particle swarm optimization algorithm to solve the objective function, the current optimal value P_{good} of particles, which meet a certain condition, is mutated according to the probability P_{prob}, and an original movement direction of the particles is changed through the changes, so as to better realize global optimization.

If fᵢ is set as the adaptability (the objective function value) of an i^{th} particle, an expression of the average adaptability of a whole swarm is:

$${f}_{average} = \frac{1}{n} {\sum }_{i = 1}^{n} {f}_{1}$$

wherein in the formula, n represents the number of particles; f represents the adaptability of the i^{th} particle; and f_{average} represents the current average adaptability.

Firstly, the adaptability variance σ² of a particle swarm is set as:

$${σ}^{2} = {\sum }_{i = 1}^{n} {[ \frac{{f}_{i} - {f}_{average}}{{f}_{normalization}} ]}^{2}$$

wherein in the formula, f_{normalization} represents a normalization factor, which is used for limiting the value of the adaptability variance of the particles;

the value of a normalization scaling factor f of the particle swarm is determined as follows:

$$f = \{ \begin{matrix}max \{ \vert {f}_{i} - {f}_{average} \vert \} , max \{ \vert {f}_{i} - {f}_{average} \vert \} > 1 \\ 1 , max \{ \vert {f}_{i} - {f}_{average} \vert \} \leq 1\end{matrix}$$

and the calculation formula of P_{prob} is:

$${P}_{prob} = \{ \begin{matrix}A , {σ}^{2} < {σ}_{known}^{2} \& f ( good ) < {f}_{theory} \\ 0 , others\end{matrix}$$

wherein in the formula, A represents an arbitrary value, and A∈[0.1, 0.3]; σ_{known}² represents the given adaptability variance, and the value of σ_{known}² is much less than the maximum value of σ² generally; and f_{theory} represents the theoretical optimal value.

An mutation operation is carried out on P_{good} by increasing disturbance, so

P_{good}^{A}=P_{good}^{A}(1+0.5μ)

wherein in the formula, P_{good}^{A} represents the A-dimensional value of P_{good}; and a random variable P complies with Gaussian (0,1) distribution.

According to the above analysis, a corresponding solving process of the optimization algorithm is obtained, which is shown as follows:

1) initializing the positions and speed of the particles in the particle swarm according to relevant parameters;

2) calculating the adaptability of each particle according to the objective function;

3) evaluating the individual extremum and the global extremum of the particles;

4) judging that whether the number of iterations is reached; if the result is true, stopping calculation and outputting the optimal value; and if the result is false, carrying out an mutation operation and updating the position and speed of the particle swarm;

5) updating the variable in the objective function and calculating the adaptability;

6) then updating serial numbers of particles in an optimal group of the particle swarm; and

7) judging that whether the number of iterations is reached again and continuing to circulate the Step 4).

The optimal charging quantity of the electric vehicles and the optimal charging/discharging power of the electric vehicles are solved finally. According to the dispatching method, the electric vehicles can participate in wind power consumption to minimize the remaining blocked quantity of wind power, and meanwhile, the total charging cost of the electric vehicles can be lowest.

The embodiment provides a method for optimizing dispatching of charging loads of electric vehicles to promote wind power consumption, which comprises: acquiring a model for optimizing the charging loads of the electric vehicles to promote wind power consumption, wherein an objective function of the optimization model refers to that the electric vehicles participate in wind power consumption to minimize the remaining blocked quantity of wind power, and the total charging cost of the electric vehicles is lowest; and solving an optimal solution of the optimization model based on an adaptive mutation particle swarm optimization algorithm, so as to obtain target charging loads and power, wherein the obtained targets can enable the wind power consumption to be maximal and enable the total charging cost of users of the electric vehicles to be lowest, can effectively relieve the peak of loads of power grids and can improve the consumption of clean energy. According to the method for optimizing dispatching of the charging loads of the electric vehicles to promote wind power consumption, which is provided by the embodiment, the problem that a lot of wind abandonment electric quantity is caused by the fluctuation of output of new energy can be considered, and the total charging cost of the users of the electric vehicles is lowest while the harm to the peak of the power grids is relieved. Therefore, the method can be used for solving the problems of a lot of wind abandonment phenomena and disorderly charging of the electric vehicles.

The present invention is described in detail through the above embodiments, but the contents are only preferred embodiments of the present invention and shall not be regarded as a limitation to the implementation scope of the present invention. Any equivalent change and improvement made according to the application scope of the present invention shall belong to the scope covered by the patent of the present invention.

We claim:

1. A method for optimizing dispatching of charging loads of electric vehicles to promote wind power consumption, comprising the following steps:
acquiring blocked electric quantity of wind power at a peak down-regulation period;
acquiring a curve of disorderly charging loads of electric vehicles;
establishing a model for optimizing the charging loads of the electric vehicles to promote wind power consumption, wherein an objective function of the model refers to that the electric vehicles participate in wind power consumption to minimize the remaining blocked quantity of the wind power, and the total charging cost of the electric vehicles is lowest; and acquiring constraint conditions of the model;
solving the optimization model by adopting an adaptive mutation particle swarm optimization algorithm, to obtain target charging/discharging electric quantity and target charging/discharging power of the electric vehicles.

2. The method for optimizing dispatching of charging loads of electric vehicles to promote wind power consumption according to claim 1, wherein a method of establishing the model for optimizing the charging loads of the electric vehicles to promote wind power consumption comprises:
establishing a model that the electric vehicles participate in wind power consumption to minimize the remaining blocked quantity of the wind power:
$${f}_{1} = min ( {E}_{B , t} - {E}_{EV , t} ) , t ∈ T \\ {E}_{EV , t} = {\sum }_{i = 1}^{{N}_{EV}} {P}_{c , i}^{t} Δ t$$
wherein in the formulas, f₁ represents the remaining blocked quantity of the wind power; E_{B,t} represents the blocked electric quantity at the peak down-regulation period; E_{EV,t} represents the charging electric quantity of the electric vehicles; T represents the peak down-regulation period; P_{c,i}^{t}, represents the charging power of an i^{th} electric vehicle at a period t; N_{EV} represents the number of the electric vehicles; and Δt represents the time scale;
establishing the objective function that the total charging cost of the electric vehicles is lowest:
$${f}_{2} = min ( {\sum }_{t = 1}^{n} {\sum }_{i = 1}^{{N}_{EV}} {P}_{c , i}^{t} * {F}_{c , t} - {\sum }_{t = 1}^{n} {\sum }_{i = 1}^{{N}_{EV}} {P}_{f , i}^{t} * {F}_{f , t} )$$
wherein in the formula, f₂ represents the total charging cost of the electric vehicles; P_{c,i}^{t} and P_{f,i}^{t} respectively represent the charging power and the discharging power of the i^{th} electric vehicle at the period t; and F_{c,t} and F_{f,t} respectively represent charging fees and discharging fees of the electric vehicles at the period t.

3. The method for optimizing dispatching of charging loads of electric vehicles to promote wind power consumption according to claim 1, wherein the constraint conditions of the model comprise a power balance constraint of a system, an output constraint of a wind power plant and relevant constraints of the electric vehicles.

4. The method for optimizing dispatching of charging loads of electric vehicles to promote wind power consumption according to claim 3, wherein the relevant constraints of the electric vehicles comprise an electric quantity constraint of the electric vehicles, a charging/discharging constraint of the electric vehicles, an SOC (State Of Charge) constraint and an online time constraint of the electric vehicles.

5. The method for optimizing dispatching of charging loads of electric vehicles to promote wind power consumption according to claim 4, wherein the power balance constraint of the system is:
$${P}_{F , t} + {\sum }_{j = 1}^{{n}_{G}} {u}_{j} * {P}_{G , j}^{t} = {P}_{L , t} + {\sum }_{i = 1}^{{N}_{EV}} ( {P}_{c , i}^{t} * {V}_{i , t} + {P}_{f , i}^{t} * {V}_{i , t} )$$
wherein in the formula, P_{F,t} represents the discharging power of the electric vehicles at the period t; P_{G,j}^{t} represents the active power output of a conventional power supply j at the period t; P_{L,t} represents the value of a system load at the period t; P_{c,i}^{t} and P_{f,i}^{t} respectively represent the charging power and the discharging power of the i^{th} electric vehicle at the period t; uⱼ=1 represents that units operate normally, and uⱼ=0 represents that the units stop operating; V_{i,t} represents a charging state and a discharging state of the i^{th} electric vehicle at the period t, V_{i,t}=1 represents that the vehicle is in the charging state, and V_{i,t}=−1 represents that the vehicle is in the discharging state; n_{G} represents the number of units; and N_{EV} represents the number of the electric vehicles;
the output constraint of the wind power plant is:
min P_{F,t}≤P_{F,t}≤max P_{F,t}
wherein in the formula, min P_{F,t} and max P_{F,t} respectively represent the upper limit and the lower limit of power of wind power output at t^{th} period;
the electric quantity constraint of the electric vehicles is:
Qᵢ≥Q_{i,t}_{ₙ₁}−P_{f,i}^{t}*Δt_{f}+P_{c,i}^{t}*Δt_{c}
wherein in the formula, Qᵢ represents the electric quantity after the electric vehicles are charged/discharged; Q_{i,t}_{ₙ₁} represents the electric quantity before the electric vehicles are charged/discharged; Δt_{c} and Δt_{f} respectively represent the charging duration and the discharging duration;
the charging/discharging constraint of the electric vehicles is:
0≤P_{c,i}^{t}≤P_{c,max}
0≤P_{f,i}^{t}≤P_{f,max}
P_{c,i}^{t}*P_{f,i}^{t}=0
wherein in the formulas, P_{c,max} represents the upper limit of the charging power of the electric vehicles, and P_{f,max} represents the upper limit of the discharging power of the electric vehicles;
the SOC constraint is:
SOC_{d,i}≤SOC_{e,i}≤SOCₘₐₓ
wherein in the formula, SOC_{e,i} represents an SOC of the i^{th} electric vehicle when the charging is ended; SOC_{d,i} represents an expected SOC of the i^{th} electric vehicle; and SOCₘₐₓ represents the upper limit of charging, which is set by a power battery;
the online time constraint of the electric vehicles is:
Tᵢₙ≤T_{c}≤Tₒᵤₜ
Tᵢₙ≤T_{f}≤Tₒᵤₜ
wherein in the formulas, Tᵢₙ represents the network access time of the electric vehicles; T_{c} represents the charging time of the electric vehicles; Tₒᵤₜ represents the off-network time of the electric vehicles; and T_{f} represents the discharging time of the electric vehicles.

6. The method for optimizing dispatching of charging loads of electric vehicles to promote wind power consumption according to claim 1, wherein a method of acquiring the blocked electric quantity of the wind power at the peak down-regulation period comprises:
solving the predicted electric quantity E_{F,wind}^{t} of wind power at each period Δt according to a prediction curve of wind power output on a next day:
E_{F,wind}^{t}=P_{F,wind}^{t}*Δt
wherein in the formula, Δt represents the time scale, and P_{F,wind}^{t} represents the power of the wind power output;
setting a peak down-regulation period and a peak non-down-regulation period of the system and acquiring the blocked electric quantity of the wind power:
T={T|E_{F,wind}^{t}≥E_{p,wind}^{t},t∈T}
wherein in the formula, E_{p,wind}^{t} represents planned wind power quantity, and T represents the peak down-regulation period;
acquiring the blocked electric quantity E_{B,t} of the wind power at the peak down-regulation period:
E_{B,t}=E_{F,wind}^{t}−E_{p,wind}^{t},t∈T.
